(19) United States
(12) Patent Application Publication
(10) Pub. No.: US 2007/0262062 A1
(43) Pub. Date: Nov. 15, 2007

(54) Motor Vehicle Internal Paneling Section and Marking Method

(75) Inventor: Oliver Guth, Dudenhofen (DE)

Correspondence Address: KAPLAN GILMAN GIBSON & DERNIER L.L.P., 900 ROUTE 9 NORTH, WOODBRIDGE, NJ, 07095, US

(73) Assignee: FAURECIA INNENRAUM SYSTEME GMBH, Hagenbach (DE)

(21) Appl. No.: 11/719,068

(22) PCT Filed: Nov. 17, 2005
(86) PCT No.: PCT/EP05/56032

§ 371 Date: Jul. 17, 2007

(30) Foreign Application Priority Data
Nov. 17, 2004 (DE) 102004055416.1

(51) Int. Cl. B23K 26/02

(52) U.S. Cl. 219/121.69

(57) ABSTRACT

The invention relates to a method for marking an interior lining part of a motor vehicle, whereby the marking is done with a laser beam, as well as an interior lining part of a motor vehicle, such as an instrument panel, a door lining or a pillar lining, provided with a laser marking

### BACKGROUND

The invention relates to an internal paneling section (which may be also referred to as an interior lining part) for a motor vehicle and a method for marking an interior lining part for a motor vehicle, e.g., an instrument panel, a door lining, or a pillar lining.

Various airbag devices are known from the prior art, including particularly such devices that are invisible from the motor vehicle interior (see, e.g., German Patents DE 101 06 661 A1, DE 103 11 854 A1, DE 101 11 597 A1, DE 103 16 226 A1 and EP 0 711 627).

In order to indicate the presence of an airbag device, it is common in prior art that an indication of the airbag device is placed in the interior of the motor vehicle. This is especially important for invisible airbag devices in order to avoid an infant being placed in a front passenger seat on the assumption that there is no airbag there.

Placement of an airbag device indication, whether a passenger airbag, driver airbag, side-impact airbag, curtain airbag, or the like, is usually done by applying the inscription “SRS airbag” on an interior lining part of a motor vehicle, which part is arranged in the area of the airbag device.

For this purpose, plastic injection molding parts carrying the SRS airbag logo are manufactured. These plastic injection molding parts are clipped onto the corresponding interior lining part of a motor vehicle. This entails relatively high installation costs and, furthermore, is often esthetically not very appealing. A further disadvantage is that a plastic injection molding part might separate during an impact, e.g., due to the force of the deploying airbag.

Another option for placing an indication of the presence of an airbag on an airbag device is described in German unexamined patent application DE 199 32 327. This document describes an interior lining part for a motor vehicle exhibiting in the area of an airbag an airbag trim cover that is invisible to the occupants, said trim cover being formed at least partially by an inner circumferential predetermined breakout line, whereby a marking indicating the presence of the airbag trim cover is provided on the outside of the interior lining part. According to the invention, this marking is arranged in an offset manner relative to the contour of the airbag trim cover or a predetermined breakout line. The marking may be formed by a circumferential groove created by a laser. The interior lining part may consist of different materials. The unexamined patent application mentions hard plastics, sprayed, stretched, blown, grained, foil-laminated or back-foamed carriers, laminated or back-foamed wood-fiber molded materials, or back-sprayed or back-pressed foils or substances.

### SUMMARY OF THE INVENTION

In consideration of the above, the problem of the invention consist in creating an improved interior lining part of a motor vehicle and an improved method for marking an interior lining part of a motor vehicle.

The problems of the invention are in each case solved by the features of the independent claims. Preferred embodiments of the invention are provided in the dependent claims.

According to the invention, marking an interior lining part of a motor vehicle is done with a laser beam, which has the advantage that a separate component or an installation step for placing the marking on the interior lining part of a motor vehicle may be omitted

According to an embodiment of the invention, the interior lining of the motor vehicle has an top layer that is penetrated by the laser beam in order to apply the marking. Where the top layer is penetrated by the laser beam, a bottom layer appears, which is visible from the interior of the motor vehicle. The top layer concerns, e.g., a decorative layer with textile, polyvinylchloride (PVC), polyolefin and/or TPO parts. The decorative layer is, for instance, of textile origin and consists of a polyester (PES) fiber or a polyolefin (PP) fiber. However, the surface of the decorative layer may also consist of a PVC foil or TPO foil.

According to an embodiment of the invention, the decorative layer is arranged on a support layer. The penetration of the decorative layer by the laser beam makes the support layer situated below become visible. In the marking area, the support layer may exhibit an impressed or lacquer coating that appears due to the penetration of the decorative layer.

According to a further embodiment, the top layer of the interior lining part of a motor vehicle contains color pigments that change color, when impinged by the laser beam. Such color pigments are known, per se, in the prior art (see DE 94 21 868 U1).

Preferably, the marking concerns an indication of an airbag device situated in the area of the marking, e.g., the SRS airbag logo. With the method according to the invention, however, other markings of an informative and/or decorative nature may be placed on an interior lining part of a motor vehicle.

According to an embodiment of the invention, the color pigments are arranged in the top layer in such a way that the marking becomes predetermined by the arrangement of the color pigments, whereby the area of the top layer containing the color pigments is illuminated with the laser beam, whereby the color pigments change color, so that the marking becomes visible. Through systematic arrangement of the color pigments in the top layer, e.g., such that the arrangement of the color pigments outline the word airbag, the top layer may be illuminated by a laser light in the area containing the arrangement of the color pigments, which will make the word airbag visible. This has the advantage of allowing the use of an especially simple laser system, since complex controlling means that would be required for outlining the word airbag on the top layer by using a laser beam are no longer needed.

The interior lining part of a motor vehicle according to the invention relates, e.g., to an instrument panel, a door lining, the lining of a pillar, e.g., a so-called A, B, C or D pillar, or an airbag cover sealing the firing channel of an airbag.

According to an embodiment of the invention, the interior lining part of a motor vehicle has a support layer consisting of a natural fiber material, e.g., a so-called flax polypropylene (PP). The support layer may consist of plastic, e.g., 30% PP LGF. A non-woven fabric may be situated on the support layer, said fabric acting as a adhesive agent for the decorative layer situated on top thereof. The other side of the support layer may have a bonding layer in order to, e.g., fasten the firing channel for the airbag by means of vibration welding.

According to a further embodiment of the invention, the support layer has a pre-weakening that realizes a detachable airbag cover. The pre-weakening represents a predetermined breakout point that is penetrated, e.g., when the deploying airbag impacts the back of the support layer in order to separate the airbag cover from the instrument panel in order release the deployment opening. The pre-weakening is, for instance, designed as a U-shaped groove, whereby the side of the airbag cover facing the root of the windshield is not weakened. This side assumes a hinge function, when the airbag cover opens.

According to a further embodiment of the invention, an electroluminescent foil may be present on the support layer. The foil becomes visible from the interior of the vehicle due to the laser marking of the top layer. The electroluminescent foil may be activated by a control device. For instance, voltage is applied to the electroluminescent foil in order to indicate whether the airbag is activated or de-activated, and/or whether the airbag is functioning or defective. This is especially advantageous for the passenger airbag, since an indication of whether an infant may be carried in the front passenger seat is then readily visible.

A CO2 laser is preferably used for the laser marking and pre-weakening, as this will save production costs.

Moreover, the inscription may advantageously be placed directly on the airbag cover. Since we are only concerned with an inscription placed on the component and not a separate component, per se, the risk of injury can be entirely excluded.

### BRIEF DESCRIPTION OF THE DRAWINGS

Preferred embodiments of the invention will be explained in more detail below with reference to the drawings. The drawings show the following:

FIG. 1. A cross-section of an interior lining part of a motor vehicle prior to laser marking.

FIG. 2. The interior lining part of a motor vehicle, as shown in FIG. 1, following laser marking.

FIG. 3. An further interior lining part of a motor vehicle with a laser marking through which a color layer becomes visible.

FIG. 4. A further embodiment of an interior lining part of a motor vehicle with a non-woven fabric.

FIG. 5. A further embodiment of an interior lining part of a motor vehicle with an airbag device.

FIG. 6. A further embodiment of an interior lining part of a motor vehicle with color pigments.

FIG. 7a. A schematic cross-section through a further embodiment of an interior lining part of a motor vehicle with color pigments.

FIG. 7b. A top view of a further embodiment of an interior lining part of a motor vehicle with color pigments.

### DETAILED DESCRIPTION OF THE INVENTION

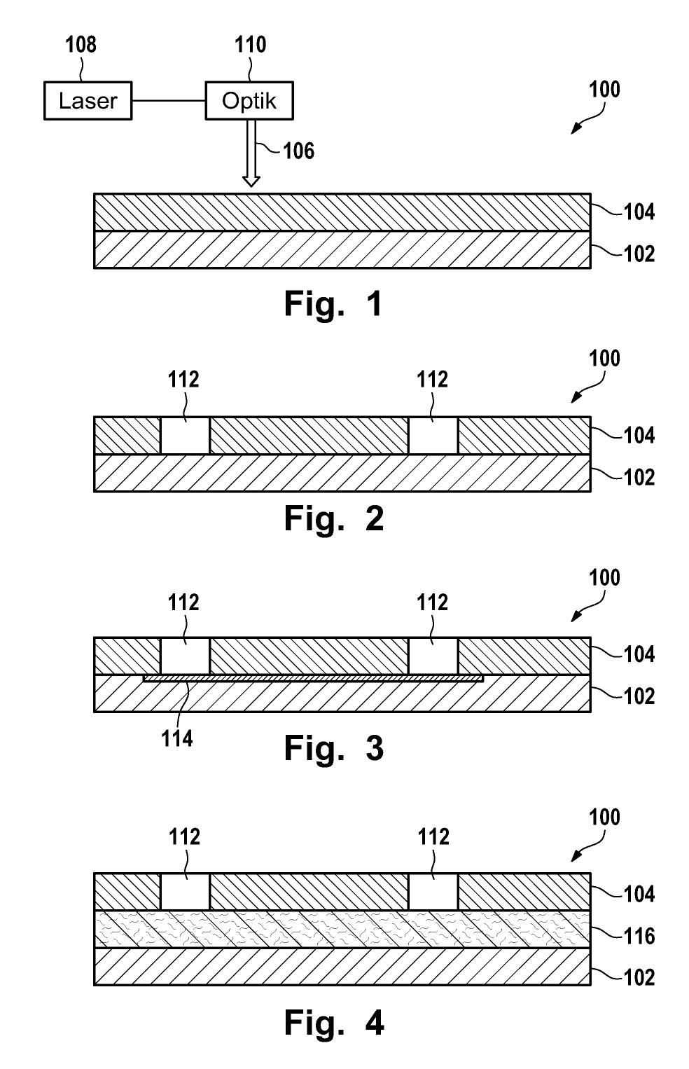

FIG. 1 shows an interior lining part 100 of a motor vehicle, such as an airbag cover, for sealing an airbag firing channel, an instrument panel, a door lining, or the lining of motor vehicle pillar, e.g., so-called A, B, C or D pillars.

The interior lining part 100 of a motor vehicle has a carrier 102 containing a decorative layer 104. The marking of the interior lining part 100 of a motor vehicle is done by a laser beam 106 delivered by a laser 108 and an optical system 110 aimed at the location of the decorative layer 104 to be marked [translator's note: corrected for slightly ungrammatical sentence]. The laser 108 preferably concerns a CO2 laser delivering a sufficiently strong laser beam 106 in order to penetrate the layer 104.

FIG. 2 shows the interior lining part 100 of a motor vehicle after placement of the marking. Due to the laser beam 106, grooves 112 extending as far down as the carrier 102 were incised, thus making the surface of carrier 102 in the mounting position of the interior lining part 100 of a motor vehicle visible from the interior of the motor vehicle. The decorative layer 104 and carrier 102 preferably have contrasting colors, so an inscription with a different color than that of the decorative layer 104 becomes visible through the grooves 112.

FIG. 3 shows an alternative embodiment of the interior lining part 100 of a motor vehicle with a color layer 114 applied on the carrier 102 in the area of the marking. Color layer 114 may concern a lacquer coat or an imprint. The application of such a color layer 114 is especially advantageous, when the color contrast between the decorative layer 104 and the surface of the carrier 102 is insufficient for making the marking clearly visible. Moreover, the color layer 114 affords greater creative freedom, e.g., adapting the inscription that is prominent due to the laser marking to another color arrangement of the interior of the motor vehicle.

FIG. 4 shows a further embodiment of the interior lining part of a motor vehicle with a non-woven fabric 116 situated on the carrier 102. The non-woven fabric 116 may serve as an adhesive agent between the decorative layer 104 and the carrier 102. In this case, the surface of the non-woven fabric 116 becomes visible through the grooves 112 incised by the laser beam 106.

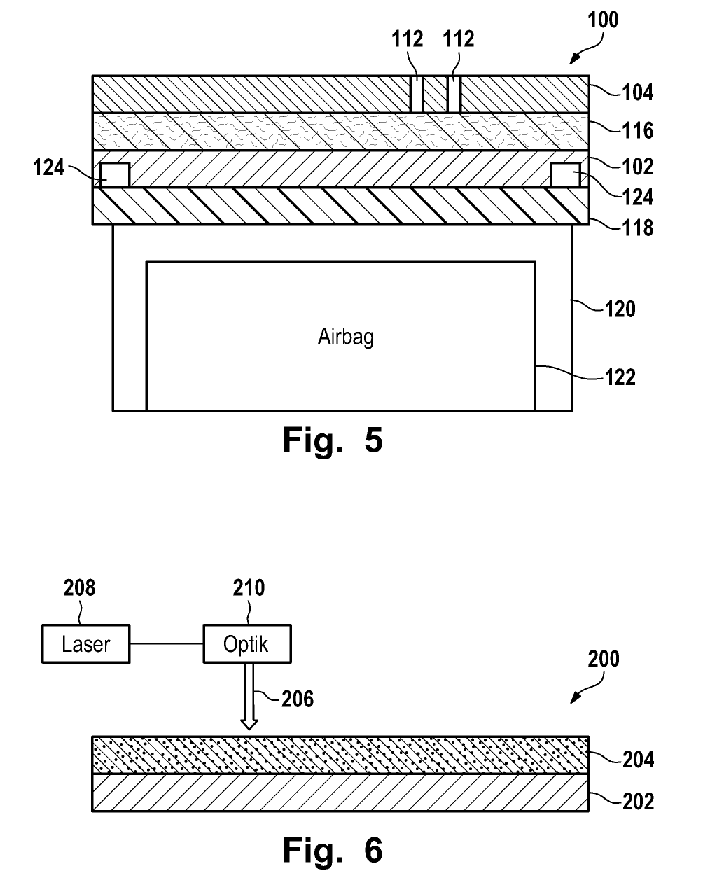

FIG. 5 shows an embodiment of the interior lining part 100 of a motor vehicle as a further development of the embodiment according to FIG. 4. In the embodiment of FIG. 5, the interior lining part 100 of a motor vehicle has a bonding layer 118 on the side opposing the non-woven fabric 116. The bonding layer 118 may, e.g., concern a bonding foil consisting of polypropylene. The bonding foil has a thickness of less than, e.g., 100 μm.

The bonding layer 118 serves to fasten the firing channel 120 of an airbag 122. To fasten the firing channels 120 to the bonding layer 118, a vibration welding method may, for instance, be used.

Carrier 102 has grooves 124 serving to pre-weaken the carrier 102, thereby realizing a detachable airbag cover. After triggering the airbag 122, the deploying airbag 122 strikes the back of the carrier 102. As a result of this impact, the area of the carrier 102 situated between the grooves 124 detaches, thereby releasing the airbag deployment opening.

Preferably, the grooves 112 in the decorative layer 104 and the grooves 124 in the carrier 102 are produced with the same laser, preferably a CO2 laser.

It should be pointed out that the grooves 112 need not necessarily penetrate the decorative layer 104 completely. A groove structure on the decorative layer 104 not extending all the way to the carrier 102 and/or the color layer 114 or the non-woven fabric 116 (see here the embodiments of FIGS. 3 and 4), may be perceived by the vehicle occupants as an inscription, decoration and/or logo.

FIG. 6 shows a further embodiment of an interior lining part 200 of a motor vehicle according to the invention. The interior lining part 200 of a motor vehicle has a carrier 202 containing a decorative layer 204. The decorative layer 204 contains color pigments.

The marking of the decorative layer 204 is done by aiming a laser beam 206 at the area of the decorative layer 204 to be marked. The laser beam 206 is supplied by a laser 208 and aimed at the area to be marked via a suitable optical system 210. Where the laser beam 206 impinges the decorative layer 204, the color pigments in the decorative layer 204 are chemically and/or physically converted, which causes a localized change of color. Preferably, the laser 208 concerns a YAK laser.

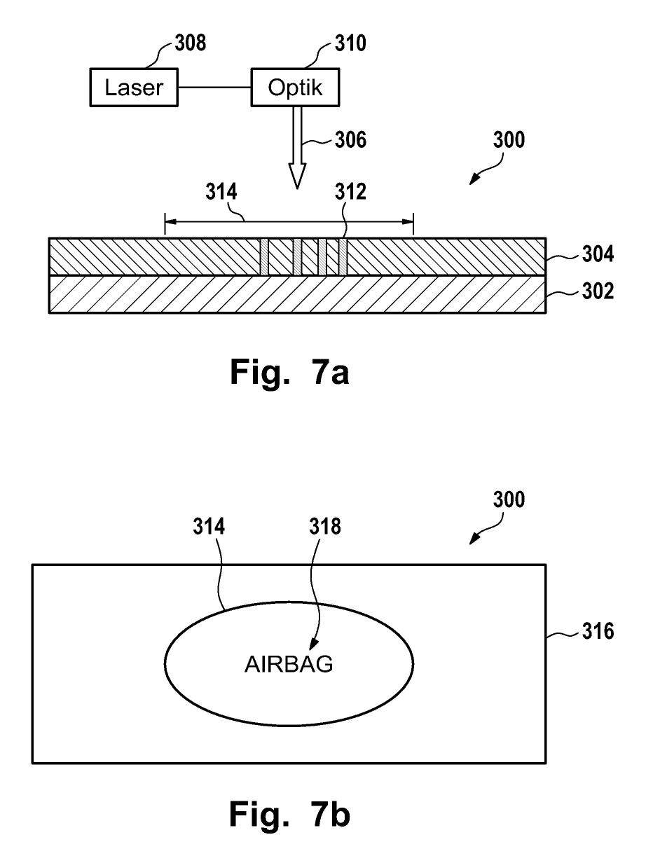

FIG. 7a shows a schematic cross-section through a further embodiment of an interior lining part 300 of a motor vehicle according to the invention.

The interior lining part 300 of a motor vehicle consists of a support layer 302 and a decorative layer 304. The decorative layer 304 contains color pigments 312, whereby a marking is predetermined due to the arrangement of the color pigments within an area 314 of the decorative layer 304. By exposing the area 314 to a laser beam 306, the color pigments 312 change color. The laser beam 306 is created by a laser 308. The laser beam 306 is thereby either expanded by the optical system 310 such, that the area 314 is illuminated by the laser beam 306 as a whole, or the optical system 310 guides the laser beam 306 such, that the area 314 is gradually illuminated by the laser beam 306.

FIG. 7b is a top view of the interior lining part 300 of a motor vehicle, as shown in cross-section in FIG. 7a. The area 314 thereby comprises a part of the surface 316 of the decorative layer, whereby the arrangement of the color pigments within the area 314 is predetermined such, that the arrangement outlines the word “airbag.” The marking 318 in this case thus corresponds to the word “airbag.” The marking 318, that is to say, the word “airbag,” becomes visible due to the color pigments 312 changing color, when struck by the laser light.

### REFERENCE SIGN LIST

100 Interior lining part of a motor vehicle

102 Carrier

104 Decorative layer

106 Laser beam

108 Laser

110 Optical system

112 Grooves

114 Color coat

116 Fleece

118 Bonding layer

120 Firing channel

122 Airbag

124 Grooves

200 Interior lining part of a motor vehicle

202 Carrier

204 Top layer

206 Laser beam

208 Laser

210 Optical system

300 Interior lining part of a motor vehicle

302 Carrier

304 Top layer

306 Laser beam

308 Laser

310 Optical system

312 Color pigments

314 Area

316 Top layer surface

318 Marking

1. A method for marking an internal paneling section of a motor vehicle, comprising marking the internal paneling section in an area of an airbag cover with a laser beam, whereby a top layer of the internal paneling section is penetrated by the laser beam so that a bottom layer of the internal paneling section becomes visible.

2. (canceled)

3. A method according to claim 1, whereby the top layer includes a decorative layer having a textile, PVC and/or TPO part.

4. (canceled)

5. A method according to claim 1, whereby the internal paneling section of the motor vehicle includes a decorative layer and a support layer, and the decorative layer is penetrated by the laser beam.

6. A method according to claim 1, whereby the internal paneling section of the motor vehicle is part of an instrument panel.

7. (canceled)

8. (canceled)

9. (canceled)

10. A method according to claim 1, whereby the internal paneling section of a motor vehicle is part of an airbag cover.

11. (canceled)

12. An internal paneling section of a motor vehicle comprising:
a top layer visible in a mounting position from an interior of the motor vehicle; and
a bottom layer,
wherein the top layer includes laser marking in an area of an airbag cover in which the top layer has been penetrated by the laser marking so that the bottom layer of the internal paneling section in the mounting position is visible.

13. (canceled)

14. An internal paneling section of a motor vehicle according to claim 12, whereby the top layer includes a decorative layer, whereby the decorative layer includes a textile, PVC and/or TPO part.

15. (canceled)

16. (canceled)

17. An internal paneling section of a motor vehicle according to claim 12, whereby the bottom layer includes a support layer.

18. An internal paneling section of a motor vehicle according to claim 12, whereby the bottom layer includes a color layer situated on a support layer.

19. An internal paneling section of a motor vehicle according to claim 18, whereby the color layer is impressed on the support layer.

20. An internal paneling section of a motor vehicle according to claim 18, whereby the color is impressed on the support layer such that a marking is predetermined due to an arrangement of color pigments of the color layer.

21. An internal paneling section of a motor vehicle according to claim 18, whereby the color layer includes a lacquer coat.

22. An internal paneling section of a motor vehicle according to claim 18, whereby the bottom layer includes a non-woven fabric.

23. An internal paneling section of a motor vehicle according to claim 18, further comprising a support layer formed from a natural fiber mat.

24. An internal paneling section of a motor vehicle according to claim 18, further comprising a support layer having a bonding layer for placing an airbag firing channel.

25. An internal paneling section of a motor vehicle according to claim 18, whereby the support layer includes a pre-weakening for realizing a detachable airbag cover.

26. (canceled)

27. An internal paneling section of a motor vehicle according to claim 18, whereby the internal paneling section forms part of an instrument panel.

28. An internal paneling section of a motor vehicle according to claim 18, whereby the internal paneling section forms part of an airbag cover.

29. An internal paneling section of a motor vehicle according to claim 18, whereby the internal paneling section forms part of a door lining.

30. An internal paneling section of a motor vehicle according to claim 18, whereby the internal paneling section forms part of a pillar lining.

31. An internal paneling section of a motor vehicle according to claim 18, further comprising an electroluminescent layer on the bottom layer in the area of the laser marking.

32. An internal paneling section of a motor vehicle according to claim 31, further comprising a control device for operating the electroluminescent layer depending on an operating condition.

33. An internal paneling section of a motor vehicle according to claim 32, whereby the control device is operable to activate the electroluminescent layer in order to indicate whether the airbag is activated or deactivated.

34. An internal paneling section of a motor vehicle according to claim 33, whereby the control device is operable to activate the electroluminescent layer in order to indicate whether the airbag has a malfunction.
